(19) United States
(12) Patent Application Publication
(10) Pub. No.: US 2008/0248195 A1
(43) Pub. Date: Oct. 9, 2008

(54) Method for the Production of Iridium Oxide Coatings

(75) Inventors: Manfred T. Reetz, Mulheim an der Ruhr (DE); Hendrik Schulenburg, Stilli (CH)

Correspondence Address: NORRIS, MCLAUGHLIN & MARCUS, PA, 875 THIRD AVENUE, 18TH FLOOR, NEW YORK, NY, 10022, US

(73) Assignee: Studiengesellschaft Kohle MBH, Mulheim an der Ruhr (DE)

(21) Appl. No.: 10/599,434

(22) PCT Filed: Mar. 9, 2005
(86) PCT No.: PCT/DE2005/000399

§ 371 Date: Sep. 28, 2006

(51) Int. Cl. B05D 5/12

(52) U.S. Cl. 427/126.5

(57) ABSTRACT

Disclosed is a method for producing iridium oxide coatings, comprising the following steps: a) colloidal IrOₓ, wherein x represents a number from 1 to 2, is applied to a surface; b) the coated surface is dried; and c) the surface is burned at a temperature ranging between 300 and 1000 ° C. Steps a) to c) can be repeated until the desired layer thickness has been obtained. Using colloidal IrOₓ as an initial component for producing IrOₓ coatings prevents toxic gases from forming during burning process.

The present invention relates to a process for producing coatings of iridium oxide, to colloidal iridium oxide and to a process for producing colloidal iridium oxide.

Metal oxide-coated titanium electrodes are used as the anode in several electrochemical processes. Examples are chloralkali electrolysis, harmful substance oxidation in water, water electrolysis and electrolytic metal deposition. In the latter two processes, metal oxide-coated anodes are used for the evolution of oxygen. Iridium oxide coatings in particular have been found to be useful for the electrocatalysis of evolution of oxygen. Iridium mixed oxides such as IrOx-SnO₂, IrRuOx, IrOₓ-Ta₂O₅ and IrOₓ-Sb₂O₅-SnO₂ can also be used for the coating.

Oxide-coated titanium electrodes are usually produced by thermal decomposition of metal salts. In this case, suitable metal salts are dissolved in water or alcohols and the electrodes are wetted with the solution. Subsequently, the wetted electrodes are heated typically at temperatures between 400 and 700° C. The metal salts decompose under these conditions and form the corresponding metal oxides or mixed oxides. The electrodes which are produced in this way often have a good mechanical stability, a satisfactory lifetime and exhibit low excess voltage for the evolution of oxygen.

In the British patent GB 1 399 576, titanium sheets are immersed into aqueous IrCl₃ and TaCl₅ solutions and pyrolyzed at temperatures of from 450 to 600° C. The operation is repeated from 12 to 15 times. The electrodes thus produced have low excess voltages for the evolution of oxygen and lifetimes of more than 2000 hours. Owing to their high iridium loading (at least 7.5 g of iridium per square meter of titanium), the electrodes are expensive.

U.S. Pat. No. 3,234,110 discloses that titanium sheets are spread over with ethanolic IrCl₄ solution and heated to 250-300° C. The operation is repeated 4 times. The resulting Ti/IrOₓ electrodes can be used for the electrolysis of NaCl solutions. There is no information about the lifetime of the coating during the evolution of chlorine.

U.S. Pat. No. 3,926,751 describes a process for producing Ti/IrTaOₓ electrodes. Titanium sheets are immersed into a solution of IrCl₃ and TaCl₅ from 12 to 15 times and in each case heated at from 450 to 550° C. During the evolution of oxygen, the electrodes exhibit a lifetime in 10% sulfuric acid of about 6000 h.

U.S. Pat. Nos. 5,294,317, 5,098,546 and 5,156,726 describe processes for producing electrodes for the evolution of oxygen. Repeated, generally 10-fold, immersion into butanolic solutions of H₂IrCl₆ and tantalum ethoxide and subsequent firing at 500° C. produces titanium electrodes which are coated with mixed oxides. For the electrodes, a lifetime of more than 2000 hours is reported.

The above-described electrode coatings by thermal decomposition of metal salts have the disadvantage that toxic gases are released in the course of firing of the electrodes, in particular Cl₂ and HCl.

F. I. Mattos-Costa, P. de Lima-Neto, S. A. S. Machado and L. A. Avaca describe, in Electrochim. Acta 1998, 44, 1515, a further means of producing Ti/IrRuOₓ electrodes. Titanium sheets are sandblasted, etched with 10% oxalic acid and immersed into an alcoholic ruthenium acetylacetonate/iridium acetylacetonate solution. Subsequently, the wetted electrodes are pyrolyzed at 400-600° C. The wetting and pyrolysis process is repeated several times until a coating thickness of at least 2 μm has been attained. In this process, although chlorine-free metal salts are used as reactants, the disadvantage of this process lies in the significantly higher costs of the chlorine-free metal salts used in comparison to the corresponding chlorides.

It is an object of the invention to develop a process which does not have the above-described disadvantages and enables the production of coatings from iridium oxides using low-chloride compounds. It is a further object of the invention to coat titanium electrodes with low-chloride iridium oxides.

The present invention provides a process for producing coatings of iridium oxide, comprising the following steps:
a) applying colloidal IrOₓ where x is from 1 to 2 to a surface,
b) drying the coated surface and
c) firing the surface at a temperature of from 300 to 1000° C.,
   steps a to c being repeatable until the desired layer thickness has been obtained.

It has been found that, surprisingly, the use of colloidal IrOₓ as the starting component for producing coatings of IrOₓ allows the formation of toxic gases during firing to be avoided. The reactants used for the preparation of the iridium oxide colloids are inexpensive iridium chlorides.

According to the invention, the process according to the invention is performed by using colloidal iridium oxide. Iridium oxides typically have the formula IrOₓ where x is from 1 to 2. Particularly uniform coatings can be obtained with particle sizes of ≦10 nm, in particular ≦3 nm.

The colloidal iridium oxide used in accordance with the invention can be obtained in any manner known from the prior art. In a preferred embodiment, it is prepared by admixing an aqueous, alcoholic and/or aqueous alcoholic solution of an Ir salt, optionally with stirring, with a Brønsted base. Particularly suitable Brønsted bases are alkali metal hydroxides, especially NaOH or KOH. A colloidal iridium oxide solution is formed. In a preferred embodiment, the solution of the Ir salt is adjusted to a pH of >11, preferably ≧12.

To prepare the colloidal iridium oxide, preference is given to using water-soluble Ir salts. The water-soluble Ir salts may be selected from the halides, nitrates, sulfates, acetates, acetylacetonates, the hydrates of the above, and also the mixed salts with other metal salts, especially the alkali metal-iridium salts. Particular preference is given to IrCl₃.H₂O, IrCl₄.H₂O, H₂IrCl₆.H₂O, Na₂IrCl₆.H₂O, K₂IrCl₆.H₂O.

The process according to the invention can be employed to coat any surfaces which are stable at the firing temperature. It is particularly suitable for coating metal and metal oxide surfaces, especially of Ti, TiO₂, ZnO, SnO₂ and glass.

A particularly suitable field of use for the process according to the invention is the coating of Ti electrodes. Such electrodes are used for the evolution of oxygen and evolution of chlorine or for the oxidation of organic residues in drinking water.

Colloidal iridium oxide as used in the above-described process is novel. The present invention accordingly further provides colloidal iridium oxide which has a particle size of ≦10 nm, in particular <3 nm.

The colloidal iridium oxide can be obtained by adjusting an aqueous, alcoholic or aqueous alcoholic solution of an Ir salt with stirring to a pH of >11, preferably ≧12, and subsequently stirring the resulting mixture at a temperature of from 0 to 100° C. over a period of from 3 to 72 hours.

The resulting iridium oxide can be used to produce the coatings without further workup. Purification and optional removal of undesired soluble ingredients can, if required, be effected by dialysis.

The process according to the invention has found a way in which iridium chlorides can be converted to iridium oxide colloids by basic hydrolysis. Surprisingly, the colloids have been prepared as concentrated hydrosols without additional stabilizers. The chloride concentration of the solution can, if desired, be greatly reduced by dialysis. Titanium substrates can be wetted with the worked-up colloidal solution. The firing of the wetted electrodes leads to continuous IrOₓ films. During the firing operation, only minimal amounts, if any, of toxic gases are released, since any chloride is bound in the form of salts, as the alkali metal chloride in the case of use of the alkali metal hydroxides as the Brønsted base.

### EXAMPLES

Coating of Titanium Electrodes with Iridium Oxide

Pretreatment of the Titanium Substrates

Titanium sheets were sandblasted, transferred into deionized water and cleaned with ultrasound for 10 min. Subsequently, the sheets were placed into hot (70-90° C.) 10% oxalic acid for 5 min and rinsed off with deionized water, before they were cleaned with ultrasound for another 10 min.

Preparation of the Colloidal Iridium Oxide Solution

353 mg of IrCl₃.H₂O (54.4% Ir) were dissolved in 10 ml of deionized water with stirring, 0.7 ml of saturated potassium hydroxide solution was added and the mixture was stirred at room temperature for 24 h. This formed a blue-violet solution. The solution was dialyzed against deionized water for 24-48 h.

Coating of the Titanium Substrates

The pretreated titanium sheets were immersed into the dialyzed colloidal IrOₓ solution and dried at 80° C. for 5 min, before they were fired at 600° C. for 5 min. This coating process was repeated 5 times. The firing operation was carried out over 1 hour.

1. A process for producing coatings of iridium oxide, comprising the following steps:
a) applying colloidal IrOₓ where x is from 1 to 2 to a surface,
b) drying the coated surface, and
c) firing the surface at a temperature of from 300 to 1000° C.,
steps a to c being repeatable until a desired layer thickness has been obtained.

2. The process as claimed in claim 1, wherein the colloidal IrOₓ where x is from 1 to 2 is obtained by admixing an aqueous, alcoholic and/or aqueous alcoholic solution of an Ir salt, optionally with stirring, with a Brønsted base.

3. The process as claimed in claim 2, wherein the Brønsted base used comprises an alkali metal hydroxide.

4. The process as claimed in claim 3, wherein an aqueous solution of the Ir salt is used, and the aqueous solution of the Ir salt is adjusted to 25 a pH of >12.

5. The process as claimed in claim 2, wherein the Ir salt is selected from the group consisting of halides, nitrates, sulfates, acetates, acetylacetonates, the hydrates of the above and the mixed salts thereof with other metal salts.

6. The process as claimed in claim 1, wherein the surfaces to be coated is selected from the group consisting of metal and metal oxide surfaces.

7. The process as claimed in claim 6, wherein the surface to be coated is the surface of a Ti electrode.

8. Colloidal iridium oxide which has a particle size of ≦10 nm.

9. A process for preparing colloidal iridium oxide, said process comprising adjusting the pH to >12 of an aqueous, alcoholic or aqueous-alcoholic solution of an Ir salt, optionally with stirring, and subsequently stirring the resulting mixture at a temperature of from 0 to 100° C. over a period of from 3 to 72 hours.

10. The process as claimed in claim 3, wherein the alkali metal hydroxide is selected from the group consisting of NaOH and KOH.

11. The process as claimed in claim 4, wherein the aqueous solution of the Ir salt is adjusted to 25 a pH of >13.

12. The process as claimed in claim 5, wherein the Ir salt is selected from the group consisting of alkali metal-iridium salts.

13. The process as claimed in claim 12, wherein the Ir salt is selected from the group consisting of IrCl₃.H₂O, IrCl₄.H₂O, H₂IrCl₆.H₂O, Na₂IrCl₆.H₂O, and K₂IrCl₆.H₂O.

14. The process as claimed in claim 6, wherein the surface is selected from the group consisting of Ti, TiO₂, ZnO, SnO₂ and glass.

15. The process as claimed in claim 7, wherein the Ti electrode is a Ti electrode for the evolution of oxygen and evolution of chlorine or an electrode for the oxidation of organic residues in drinking water.

16. The colloidal iridium oxide as claimed in claim 8, which has a particle size of ≦3 nm.

17. The process as claimed in claim 9, wherein the pH of the solution of the Ir salt is adjusted to a pH ≧13.
